(19) United States
(12) Patent Application Publication
(10) Pub. No.: US 2016/0169936 A1
(43) Pub. Date: Jun. 16, 2016

(54) SPEEDOMETER CORRECTION DEVICE

(71) Applicant: Technical Services, Syracuse, IN (US)

(72) Inventors: Alan R. Tehan, Syracuse, IN (US); Chad D. Hudson, Winona Lake, IN (US)

(21) Appl. No.: 14/963,977

(22) Filed: Dec. 9, 2015

Related U.S. Application Data
(60) Provisional application No. 62/090,121, filed on Dec. 10, 2014.

(51) Int. Cl. G01P 21/02; G01P 1/07

(52) U.S. Cl. CPC G01P 21/02; G01P 1/07

(57) ABSTRACT

A method of correcting a vehicle speed displayed on a speedometer may include identifying a type of a control module in a vehicle. The method may additionally include determining a speed-related parameter to be revised based on the type of the control module. The method may additionally include receiving a reported vehicle speed and an actual vehicle speed. The method may additionally include determining a proportion between the reported vehicle speed and the actual vehicle speed. The method may additionally include determining a corrected value for the speed-related parameter based on the proportion between the reported vehicle speed and the actual vehicle speed. The method may additionally include detecting an end of a drive cycle. The method may additionally include transferring the corrected value of the speed-related parameter to update the control module after detecting the end of the drive cycle.

### FIELD

Some embodiments described herein generally relate to correcting a vehicle speed configured to be displayed on a speedometer.

### BACKGROUND

Unless otherwise indicated herein, the materials described herein are not prior art to the claims in the present application and are not admitted to be prior art by inclusion in this section.

A vehicle may typically use a rotational speed of a wheel, a drive shaft, a transmission shaft, or another suitable component to calculate a speed of the vehicle. An onboard control module (or processor) may use calibratable parameters that correspond to a tire dimensional attribute (e.g., a tire diameter) and/or various drivetrain component gear ratios to calculate a vehicle speed based on the rotational speed of the wheel, the drive shaft, or the transmission shaft. The vehicle speed information may be communicated to a vehicle speedometer for displaying to a user. If the tire dimensional attribute and/or one or more gear ratios are physically altered, the vehicle speedometer may display an incorrect vehicle speed if values of the tire dimension parameter(s) and/or the one or more gear ratio parameters stored in the control module are not corrected to match the physical revisions of the tire dimensional attribute and/or the one or more gear ratios.

Changes to tire dimensional attributes and gear ratios may be common aftermarket alterations for users who wish to tailor their vehicles to their own specific needs. Generally, when a tire dimensional attribute and/or one or more gear ratios of a vehicle are altered, a user may need to access an affected control module to make corrections to the corresponding tire dimension parameter(s) and/or the one or more gear ratio parameters stored in a memory coupled to the control module so that the vehicle speedometer may maintain an accurate display of the vehicle speed. A cost of a product used to access and revise values of related parameters stored in the control module may be generally high in relation to a cost of making changes to tire dimensional attributes and gear ratios. Additionally, various versions of the product may be needed to access control modules from various manufacturers, as well as to access various series and generations of control modules for each manufacturer. This may make a cost of modifying the parameters relatively high, even for a moderately sized business, when performing this type of work on various vehicle platforms.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to correcting a vehicle speed configured to be displayed on a speedometer.

In an example embodiment, a method of correcting a vehicle speed displayed on a speedometer is described. The method may include identifying a type of a control module in a vehicle. The method may additionally include determining a speed-related parameter to be revised based on the type of the control module. The method may additionally include receiving a reported vehicle speed and an actual vehicle speed. The method may additionally include determining a proportion between the reported vehicle speed and the actual vehicle speed. The method may additionally include determining a corrected value for the speed-related parameter based on the proportion between the reported vehicle speed and the actual vehicle speed. The method may additionally include detecting an end of a drive cycle. The method may additionally include transferring the corrected value of the speed-related parameter to update the control module.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment;

FIG. 2 shows an example flow diagram of a method of correcting a vehicle speed configured to be displayed on a speedometer;

FIG. 3 shows another example flow diagram of a method of correcting a vehicle speed configured to be displayed on a speedometer;

FIG. 4 is a representation that illustrates an example speedometer correction device and a portion of an example vehicle; and

FIG. 5 is a block diagram that illustrates an example computing device that is arranged for correcting a vehicle speed configured to be displayed on a speedometer.

### DETAILED DESCRIPTION OF SOME EXAMPLE EMBODIMENTS

Embodiments described herein generally relate to correcting a vehicle speed configured to be displayed on a speedometer.

Some embodiments described herein may include a speedometer correction device. The speedometer correction device may correct a speedometer error caused by changes to a vehicle's tire dimension (e.g., a physical change to a tire diameter), gear ratios, and/or other speed-related attributes. The speedometer correction device may communicate with the vehicle via a communication interface including one or more wired communication ports and/or components configured for wireless communication, such as an on-board diagnostic (OBD) port (also referred to as “OBD connector”) a universal serial bus (USB) port, a wireless transceiver, or the like or any combination thereof. By way of example, the speedometer correction device may be plugged into the vehicle's OBD port. The OBD port may include an OBD I connector, an OBD II connector, an OBD III connector, and any other suitable OBD connector. Alternately or additionally, the speedometer correction device may be plugged into another wired communication port, such as a USB port or the like, which may be associated with a navigation system, an information system, an entertainment system, or a so-described infotainment system of the vehicle. Alternately or additionally, the speedometer correction device may form a wireless communication connection with the vehicle, such as over a wireless local area network (e.g., a Wi-Fi network), personal area network (e.g., a Bluetooth network), near field communication, or the like or any combination thereof.

To perform a speedometer correction, a user (e.g., a driver of the vehicle) may operate the vehicle in a prescribed drive cycle so that an actual vehicle speed is known. For example, the user may drive the vehicle to maintain a specific speed for a certain period of time. Alternatively or additionally, the speedometer correction device may use a global positioning system (GPS) sensor located in the speedometer correction device, the vehicle, or another device to determine the actual vehicle speed. Alternately or additionally, other sensors, such as radar or laser velocity sensors, accelerometers, rollers configured to be rotated by an otherwise stationary vehicle, or the like or any combination thereof may be used to determine an actual vehicle speed. The speedometer correction device may receive a reported vehicle speed from a control module or another module of the vehicle, where the reported vehicle speed may be associated with the speed displayed on a speedometer of the vehicle. The speedometer correction device may compare the reported vehicle speed provided to the speedometer to the actual vehicle speed. The speedometer correction device may then calculate value corrections for one or more speed-related parameters based on a comparison result of the reported vehicle speed and the actual vehicle speed.

Responsive to the user performing a series of actions to signal an end of the drive cycle, the speedometer correction device may transfer one or more corrected values of the one or more speed-related parameters to the control module to update the one or more speed-related parameters stored in the control module. As a result, the reported vehicle speed outputted from the control module may be corrected to be the same as the actual vehicle speed so that the speedometer of the vehicle may display the actual vehicle speed. The end of the drive cycle may be communicated to the speedometer correction device by various sequences of one or more user actions. For example, a sequence of user actions may include bringing the vehicle to a stop, turning off the ignition, waiting for at least a specific number of seconds, and then restarting an engine of the vehicle. In these and other embodiments, the user may perform other actions to indicate an end of the drive cycle. By way of example, the end of the drive cycle may be alternately or additionally signaled by a physical input, such as pressing a button or touch screen, turning a knob, flipping a switch, or the like. Alternately or additionally, the end of the drive cycle may be triggered by motion sensors, proximity sensors, or other non-contact sensors. Alternately or additionally, the end of the drive cycle may be triggered by a verbal command or other audio signal. Alternately or additionally, the end of the drive cycle may be triggered when the vehicle speed drops below a threshold value and/or rises above a threshold value. Alternately or additionally, the end of the drive cycle may be triggered by the vehicle's location. For example, the end of the drive cycle may be triggered when the vehicle returns to the geographic origin of the drive cycle. Alternately or additionally, the end of the drive cycle may be triggered by a particular period of time passing.

In some embodiments, the speedometer correction device may or may not need the user to enter information related to a tire dimension and/or gear ratios in order to complete the calculation of parameter corrections. By utilizing the speedometer correction device, the user does not need to possess other software that is normally required in order to access the control module of the vehicle. The user may not need to know how to determine which parameters need to be revised and how to calculate the revised values. The user may not need to make parameter entries directly into the control module. The speedometer correction device may determine and correct the parameters automatically for the user.

To distinguish physical attributes of the vehicle and corresponding calibratable parameters within the control module of the vehicle, terms such as “tire dimensional attribute,” “tire dimension,” “tire diameter,” and “gear ratio” may refer to corresponding physical attributes related to the vehicle. Terms such as “tire dimension parameter,” “tire diameter parameter,” and “gear ratio parameter” may refer to corresponding calibratable parameters within the control module. More generally, the term “parameter” may refer to a variable or a calibration value within the control module. In some embodiments, adjustable entries and/or parameters in the control module may be referred to as control module calibratable parameters.

Reference will now be made to the drawings to describe various aspects of some example embodiments of the invention. The drawings are diagrammatic and schematic representations of such example embodiments, and are not limiting of the present invention, nor are they necessarily drawn to scale.

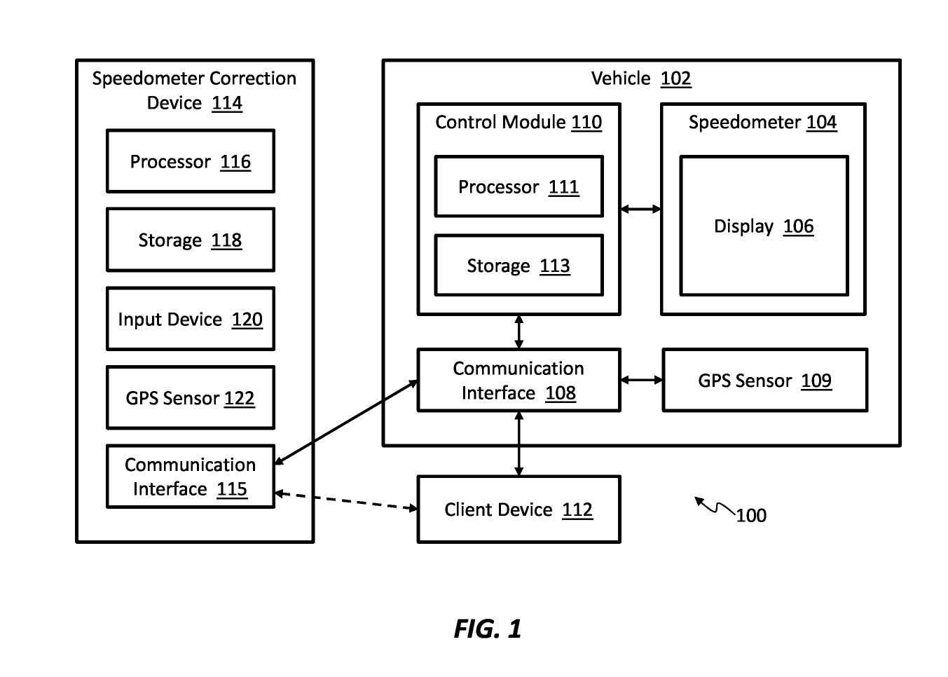

FIG. 1 is a block diagram of an example operating environment 100, arranged in accordance with at least some embodiments described herein. The operating environment 100 may include a vehicle 102, a speedometer correction device 114, a client device 112, and/or any other suitable component. In these and other embodiments, the operating environment 100 may include other servers and/or devices not shown in FIG. 1, such as a separate GPS device configured to provide an actual vehicle speed to the speedometer correction device 114. Optionally, the speedometer correction device 114, and/or the vehicle 102 may include respectively, a GPS sensor 122 and/or a GPS sensor 109 configured to provide an actual speed to the speedometer correction device 114. The vehicle 102 and the speedometer correction device 114 may cooperate with each other to correct a vehicle speed employed by the vehicle 102. For example, the vehicle 102 and the speedometer correction device 114 may cooperate with each other to correct a vehicle speed configured to be displayed via a display 106 of a speedometer 104.

In general, the vehicle 102 may include an automobile or any other type of vehicle with a speedometer. The vehicle 102 may include the speedometer 104, a communication interface 108, a control module 110, the GPS sensor 109, and/or any other suitable components not shown in FIG. 1 (e.g., a touch screen for displaying visual content and receiving user inputs).

The speedometer 104 may be configured to receive data that describes a vehicle speed from the control module 110 and to communicate the vehicle speed. For example, the speedometer 104 may display the vehicle speed on the display 106 of the speedometer 104. The speedometer 104 may include any system or device the vehicle may employ to communicate the vehicle's speed from the control module 110 to a user, such as an operator or other occupant of the vehicle. For example, the speedometer 104 may include an analog speedometer, a digital speedometer, a heads-up display, other visual displays, audio indications, or the like or any combination thereof. A vehicle speed provided by the control module 110 may be referred to herein as a reported vehicle speed.

The communication interface 108 may include one or more wired communication ports and/or components capable of wireless communication, such as an OBD-II diagnostic connector or another suitable OBD connector, and/or wireless transceivers. The communication interface 108 may give an external device or a user access to a status of various vehicle sub-systems. For example, the communication interface 108 may allow the speedometer correction device 114 to communicate with the control module 110 and to update values of speed-related parameters stored on a storage medium communicatively coupled to and/or included in the control module 110.

The control module 110 may include a processor 111 and a non-transitory storage medium 113 coupled to the processor. The control module 110 may be configured to store values of speed-related parameters on the associated storage medium 113. The control module 110 may use values of the speed-related parameters to calculate a reported vehicle speed based on a rotational speed of a wheel, a drive shaft, a transmission shaft, or another suitable component. The control module 110 may communicate the reported vehicle speed to the speedometer 104 for presenting the reported vehicle speed in the vehicle 102 via the display 106. Example speed-related parameters may include, but are not limited to, a tire dimension parameter, various drivetrain component gear ratio parameters (e.g., axle gear ratio parameters), and/or any other suitable parameters.

A tire dimension parameter may include a tire diameter parameter, a tire circumference parameter, a parameter that describes a number of tire rotations per mile or per kilometer (or, revolutions per mile or kilometer, another suitable dimension parameter of a tire that may be used to determine how many rotations the tire turns for a given distance), or any other suitable dimension parameter related to the tire.

A tire dimensional attribute may include a tire diameter, a tire circumference, an attribute that describes a number of tire rotations per mile or per kilometer (or, revolutions per mile or kilometer, another suitable dimensional attribute of a tire that may be used to determine how many rotations the tire turns for a given distance), or any other suitable dimensional attributes related to the tire.

In some embodiments, the control module 110 may receive one or more corrected values for one or more speed-related parameters from the speedometer correction device 114 via the communication interface 108. The control module 110 may update the one or more speed-related parameters stored on the control module 110 using the one or more corrected values so that a reported vehicle speed provided by the control module 110 based on the one or more corrected speed-related parameters may match an actual vehicle speed.

The client device 112 may include a computing device that includes a memory and a processor, for example, a laptop computer, a tablet computer, a mobile telephone, a personal digital assistant (PDA), or another suitable electronic device. The client device 112 may allow a user to input data to the vehicle 102. For example, the client device 112 may provide a user interface that allows a user to make revisions related to calibration parameters, speed-related parameters, and/or any other parameters. The client device 112 may be coupled to the vehicle 102 via the communication interface 108. Alternately, the client device 112 may be coupled to the communication interface 108 via the speedometer correction device 114. For example, the client device 112 may be communicatively coupled via a wired and/or wireless connection to the speedometer correction device 114 via a communication interface 115 of the speedometer correction device 114, which may also be communicatively coupled to the communication interface 108 of the vehicle 102. Alternately or additionally, the user may input data such as revisions related to calibration parameters, speed-related parameters, and/or any other parameters through a user interface included in the vehicle 102, such as through a user interface included in an infotainment system of the vehicle 102. For example, the speedometer correction device 114 may direct the infotainment system of the vehicle to display directions to the user and may monitor input to the infotainment system for the input data.

In some embodiments, the client device 112 may communicate with the control module 110 to revise one or more parameters. The parameter revisions may be made by a user through a user interface of the client device 112 or of the vehicle 102, where the user interface may display the one or more parameters in a form of a chart or a table on a display device coupled to the client device 112 or included in the vehicle 102. After entering new parameter values into the chart or the table for the one or more parameters, the user may select a calibration “download” or “flash” option so that the new parameter values may be transferred to the control module 110. The new parameter values may be stored on a memory and/or the storage medium associated with or included in the control module 110 in response to the user turning the vehicle ignition off for at least a minimum number of seconds.

In some embodiments, the speedometer correction device 114 may include input devices 120, such as switches and/or other features that allow the user to input information into the device 114. The input devices 120 may include any system or device for providing input to the speedometer correction device, such as keypads, touchscreens, non-contact sensors, voice recognition systems, audio sensors, or the like or any combination thereof. For example, the speedometer correction device 114 may include three rotary switches, each with positions from “0” to “9.” The rotary switches may be used, for example, to input a value for the axle gear ratio into the speedometer correction device 114. A gear ratio value such as 3.73 may be communicated to the speedometer correction device 114 by setting the three rotary switches such that they form the sequence “373.” In these and other examples, a user may not need the client device 112 to input information to the speedometer correction device 114. The user input may occur directly through the (multi-position) switches that may be mounted within the speedometer correction device 114.

The speedometer correction device 114 may include the communication interface 115, a processor 116, a storage medium 118, and any other suitable components. The communication interface 115 may be configured to communicatively and/or mechanically couple the speedometer correction device 114 to the communication interface 108 of the vehicle 102, a client device 112, and/or the like. The communication interface 115 may include one or more wired communication ports and/or components capable of wireless communication, such as a USB port, an OBD-II diagnostic connector or another suitable OBD connector, and/or components for forming a wireless local area network, personal area network, near field communication, or the like or any combination thereof.

The processor 116 may be of any type including, but not limited to, a central processing unit (CPU), a microprocessor (μP), a microcontroller (μC), a digital signal processor (DSP), or any combination thereof. The processor 116 may be configured to execute computer instructions that, when executed, cause the processor 116 to perform or control performance of one or more of the operations described herein with respect to the speedometer correction device 114.

The storage medium 118 may include volatile memory such as random access memory (RAM), persistent or non-volatile storage including, but not limited to, read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. Accordingly, the storage medium 118 may include a non-transitory computer-readable medium. The storage medium 118 may store computer instructions that may be executed by the processor 116 to perform or control performance of one or more of the operations described herein with respect to the speedometer correction device 114.

In some embodiments, the speedometer correction device 114 may be configured to correct one or more values for one or more speed-related parameters. The speed-related parameters to be revised may vary between numerous control module configurations. In some embodiments, a tire dimension parameter (e.g., a tire diameter parameter) and/or an axle gear ratio parameter may be revised to match physical changes that were made to the tire dimension and/or the axle gear ratio. In some applications, the tire diameter parameter may not be used directly, and a related parameter may be quantified in terms of a rolling circumference of the tire or a number of tire revolutions per mile or per kilometer. In some embodiments, the control module 110 may use a pulse parameter of “pulses per mile” or “pulses per kilometer” for communication of vehicle speed information between the control module 110 and the speedometer 104. The pulse parameter may be a composite of (1) a number of pulses that a vehicle speed sensor detects per revolution of a corresponding component monitored by the vehicle speed sensor (e.g., a wheel, axle shaft, transmission component, or another suitable component), (2) a related gear ratio parameter between the monitored component and the wheel, and (3) a number of wheel revolutions per mile or kilometer. In some embodiments, the control module 110 may use a parameter for “tire dimension correction” and the parameter for “tire dimension correction” may be revised. In some embodiments, all parameters that may affect communication of the vehicle speed to the speedometer 104 and communication of the vehicle speed between control modules (e.g., an engine control module and a transmission control module) may be revised.

The speedometer correction device 114 may be connected to any types of vehicles and may communicate with any types of control modules in the vehicles. Alternatively, the speedometer correction device 114 may be configured to operate with control modules of a specific manufacturer or with a specific series of control modules of a particular manufacturer. For example, a first model of the speedometer correction device 114 may be specific to Chrysler vehicles, a second model of the speedometer correction device 114 may be used with Subaru vehicles, and a third model of the speedometer correction device 114 may be used with a specific control module, such as a GM E38 control module.

Since the parameters to be revised may vary between manufacturers and control module configurations, the speedometer correction device 114 may identify a type of the control module 110 that the speedometer correction device 114 is connected to. For example, the speedometer correction device 114 may identify what type of control module it is connected to when the vehicle 102 is electrically powered up. In some embodiments, responsive to the ignition of the vehicle 102 being turned on, the speedometer correction device 114 may interrogate the control module 110 and may receive from the control module 110 one or more of a vehicle manufacturer, a control module type designation, major vehicle configurations such as a type of engine and transmission, a vehicle identification number (VIN), and other pieces of information.

After the speedometer correction device 114 identifies a type of the vehicle and/or a type of the control module 110 that the speedometer correction device 114 is coupled to, the speedometer correction device 114 may access a database to determine what parameters may affect the calculation and communication of the vehicle speed for the type of the control module 110. The database may be constructed by developers of the speedometer correction device 114 or any other users. The database may be stored on the speedometer correction device 114, such as in the storage medium 118, or remotely. There may be at least two different ways of approaching the selection of speed-related parameters to be corrected, and these approaches may vary per the control module and speed sensor configuration. More generally, other ways to select speed-related parameters to correct are possible.

A first approach may include implementing an overall correction entirely within a single parameter, for example, a tire dimension parameter such as a tire diameter parameter or another suitable dimension parameter related to the tire. For some control modules 110 that may sense a vehicle speed from within a transmission of the vehicle, a vehicle speed calculation may depend on a term that is a product of an axle gear ratio parameter (or its inverse) and a tire dimension parameter (e.g., a tire diameter parameter). As long as the product is correct, the sensed vehicle speed will be correct. Thus, physical changes to both the axle gear ratio and the tire dimension may be accounted for by making revisions to the tire dimension parameter only or to the axle gear ratio parameter alone. For example, a value of the tire dimension parameter may be revised to account for the physical changes to both the axle gear ratio and the tire dimension. An existing value of the axle gear ratio parameter may not need to be revised even if a physical change is also made to the axle gear ratio. In this case, even though the revised value of the tire dimension parameter does not match an actual value for the tire dimensional attribute (e.g., a revised value for the tire diameter parameter does not match an actual tire diameter) and the existing value of the axle gear ratio parameter does not match an actual axle gear ratio, the product of the axle gear ratio parameter and the tire dimension parameter is correct (e.g., the product=the revised value of the tire dimension parameter×the existing value of the axle ratio parameter=the actual value of the tire dimensional attribute×an actual value of the axle gear ratio). There may be variations to this approach, depending on what component the vehicle speed sensor may monitor and what communications may take place between various modules within the vehicle.

More generally, the speedometer correction device 114 may detect a type of the control module 110 that the speedometer correction device 114 is connected to. The speedometer correction device 114 may use a related database to determine a speed-related parameter to be modified for the type of the control module 110. The speedometer correction device 114 may calculate a proportion between the reported and actual vehicle speeds (during a drive cycle). The speedometer correction device 114 may calculate a corrected value for the speed-related parameter based on the proportion between the reported and actual vehicle speeds. For example, the speed-related parameter may be the tire diameter parameter. The actual and reported vehicle speeds are 100 kilometers per hour and 85 kilometers per hour, respectively. A proportion of the actual vehicle speed and the reported vehicle speed is 100/85=1.176. A corrected value for the tire diameter parameter may be equal to a product of an existing value of the tire diameter parameter and the proportion between the actual and reported vehicle speeds (e.g., the corrected value for the tire diameter parameter=the existing value of the tire diameter parameter×1.176). A product of the axle gear ratio parameter and the tire diameter parameter may be equal to the corrected value of the tire diameter parameter multiplied by the existing value of the axle ratio parameter and also equal to the actual value of the tire diameter multiplied by an actual value of the axle gear ratio. Responsive to the user signaling an end of the drive cycle (e.g., the user keying the vehicle off for at least a period of time and then keying the vehicle on), the speedometer correction device 114 may enter the corrected value of the speed-related parameter value into a memory or storage medium of the control module 110.

A second approach may include requesting the user of the speedometer correction device 114 to make an entry into the speedometer correction device 114, e.g., through a user interface included in and/or in communication with the client device 112, the vehicle 102, and/or the speedometer correction device 114. For example, the user may enter a new gear ratio value to the speedometer correction device 114, causing the speedometer correction device 114 to enter this information into the control module 110 in a form of a new gear ratio parameter. Next, if the speedometer correction device 114 detects that the product of the new gear ratio parameter and the tire dimension parameter is not correct (e.g., the speedometer correction device 114 senses that the actual vehicle speed does not match the reported vehicle speed from the control module 110), the speedometer correction device 114 may determine that the speedometer error may be caused by the tire dimension parameter. The speedometer correction device 114 may then correct the value for the tire dimension parameter by performing operations similar to those described above with respect to the first approach to bring the reported vehicle speed into agreement with the actual vehicle speed.

The second approach may be useful in cases where the vehicle speed sensor is at the wheel, yet the control module 110 compares an engine speed to a reported vehicle speed or an axle speed. In this configuration, for physical changes made to both the tire dimension and the axle gear ratio, the tire dimension parameter may be revised in order to correct the reported vehicle speed. A modification to the axle gear ratio may cause the engine speed to be out of the normal range as compared to the reported vehicle speed and actual vehicle speed, and this may result in a fault being reported by the control module 110. However, by having the user make an axle gear ratio entry into the speedometer correction device 110, this issue may be resolved.

In some embodiments, some vehicles may not have enough sensors to detect both a physical axle gear ratio change and a physical tire dimension change individually and to correct both of the related parameters (within the control module) individually based on the actual and reported vehicle speeds. The speedometer correction device 114 may not make corrections to the two parameters based on only one piece of information (e.g., the proportion between the actual and reported vehicle speeds). In these situations, the user may be requested to enter information for one of the two parameters such as a new value for the axle gear ratio parameter. If there is no change to the axle gear ratio, the user may confirm no change to the axle gear ratio parameter. Then, the speedometer correction device 114 may have one parameter left to correct by its own calculation and may proceed to perform operations similar to those described above with respect to the first approach. Both the first and second approaches aim to reduce multiple potential parameters to be revised to a single parameter to be revised.

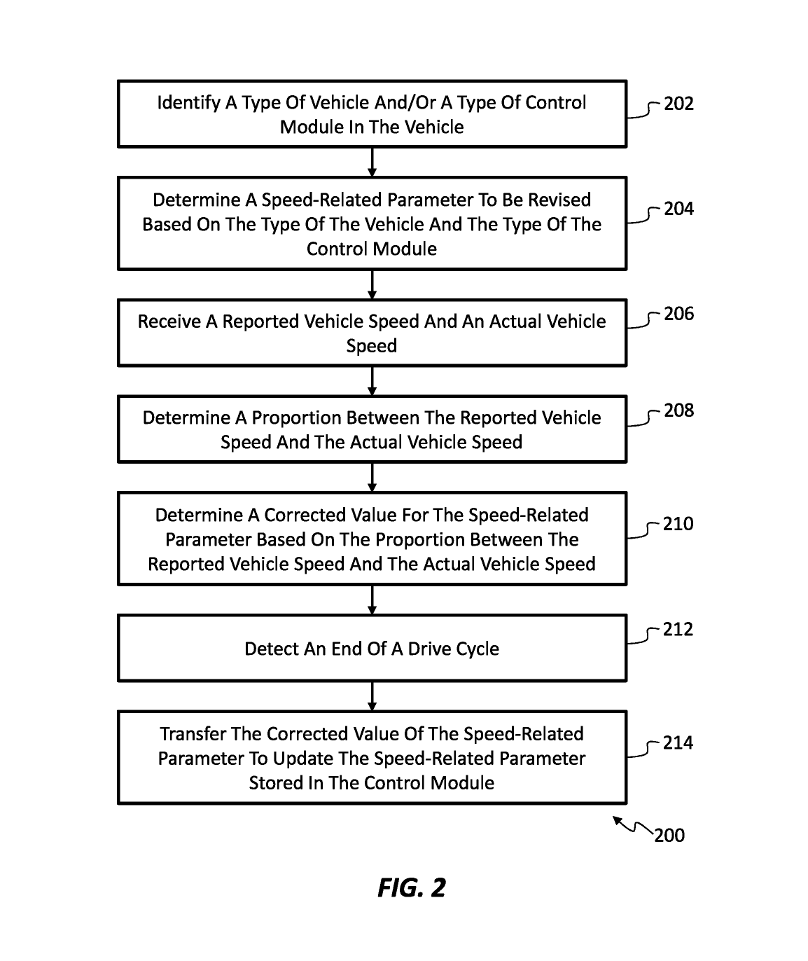

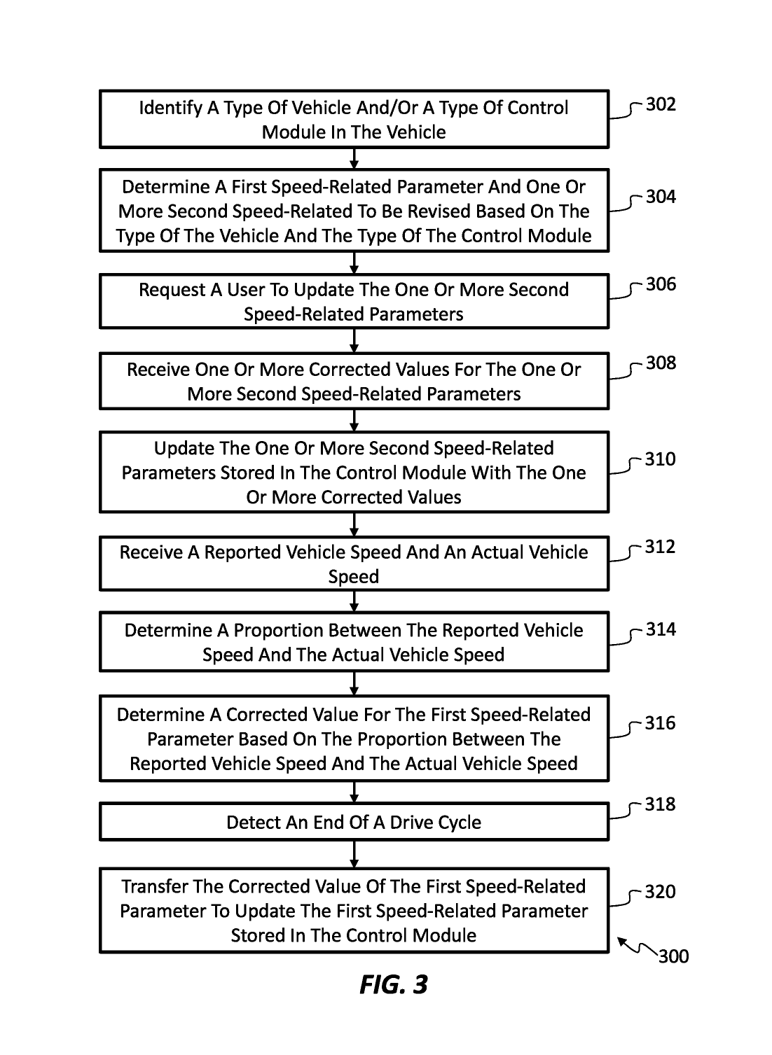

In some embodiments, the speedometer correction device 114 may perform operations similar to those described with respect to methods 200 and 300 of FIGS. 2 and 3. The methods 200 and 300 are described below in more detail.

In some embodiments, the user may perform a drive cycle so that the speedometer correction device 114 may obtain the reported and actual vehicle speeds. The user may complete a series of one or more actions that may signal to the speedometer correction device 114 that the speedometer correction device 114 may calculate corrected parameter values and download the corrected parameter values to the control module 110. The corrected parameter values may be saved in the control module 110. For example, the corrected parameter values may be saved in the control module 110 by keying off the vehicle for at least a period of time prior to restarting the vehicle. The minimum period of time that the vehicle remains keyed off for the save process may include, for example, 5 to 15 seconds. Alternatively, the period of time may be shorter than 5 seconds or greater than 15 seconds and may be determined by the design of the control module 110.

Alternatively or additionally, the corrected parameter values may be saved in the control module 110 without keying off the vehicle and/or in response to some operation other than keying off the vehicle. For example, some manufacturers may design their control modules to perform the “save” function when a specific command may be sent to the control modules. The control modules may save the corrected parameter values into an associated non-volatile memory on the fly while the vehicle is still under way. Other varied approaches may also be used to save the corrected parameter values to the control modules.

Alternatively, the user may press a button or a switch of the input devices 120 of the speedometer correction device 114 to signal the end of the drive cycle or to signal that the corrected parameter values are ready to transfer to the control module 110. For example, the user may place the vehicle in a “park” mode and push a button on the speedometer correction device 114 to signal the end of the drive cycle and that the corrected parameter values are ready to transfer to the control module 110. Alternatively, the user may perform some other series of one or more actions to signal to the speedometer correction device 114 that the speedometer correction device 114 may calculate corrected parameter values and download the corrected parameter values to the control module 110.

FIG. 2 shows an example flow diagram of the method 200 of correcting a vehicle speed configured to be displayed on a speedometer, arranged in accordance with at least some embodiments described herein. The method 200 may be performed in whole or in part by, e.g., the speedometer correction device 114 of FIG. 1. Although illustrated as discrete blocks, various blocks may be divided into additional blocks, combined into fewer blocks, or eliminated, depending on the desired implementation.

The method 200 may begin at block 202 in which a type of a vehicle and/or a type of a control module in the vehicle may be identified.

At block 204, a speed-related parameter to be revised may be determined based on the type of the vehicle and the type of the control module. For example, the method 200 may determine to revise a tire dimension parameter (e.g., a tire diameter parameter) based on the type of the control module.

At block 206, a reported vehicle speed and an actual vehicle speed may be received. For example, the reported vehicle speed may be received from the control module and the actual vehicle speed may be received from a GPS sensor and/or another device used to determine the actual vehicle speed.

At block 208, a proportion between the reported vehicle speed and the actual vehicle speed may be determined. For example, the proportion may be equal to the actual vehicle speed divided by the reported vehicle speed, or vice versa.

At block 210, a corrected value for the speed-related parameter may be determined based on the proportion between the reported vehicle speed and the actual vehicle speed. In some embodiments, the corrected value of the speed-related parameter may account for a correction related to an actual change to the corresponding speed-related attribute. Alternatively or additionally, the corrected value of the speed-related parameter may account for corrections related to one or more actual changes to one or more other speed-related attributes if the one or more actual changes to the one or more other speed-related attributes exist.

For example, for an actual vehicle speed of 110 kilometers per hour and a reported vehicle speed of 100 kilometers per hour, a proportion between the reported and actual vehicle speeds is 110/100=1.1. A corrected value for the tire dimension parameter may be equal to an existing value of the tire dimension parameter multiplied by the proportion (e.g., the corrected value of the tire dimension parameter=the existing value of the tire dimension parameter×1.1). The corrected value of the tire dimension parameter may account for corrections related to both an actual change to the tire dimension and an actual change to an axle gear ratio and may or may not be equal to an actual value of the dimensional attribute of the tire.

At block 212 an end of a drive cycle may be detected. For example, the end of the drive cycle may be detected by detecting a stop of the vehicle and detecting that an ignition of the vehicle is turned off for at least a particular number of seconds.

At block 214, responsive to the end of the drive cycle, the corrected value of the speed-related parameter may be transferred to the control module to update the speed-related parameter stored in the control module.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Some embodiments disclosed herein include an article of manufacture such as a non-transitory computer storage medium having instructions stored thereon that are executable by a computing device to perform or control performance of operations included in the method 200 of FIG. 2, such as the operations illustrated by blocks 202, 204, 206, 208, 210, 212, and/or 214 in FIG. 2, and/or variations thereof. The non-transitory computer storage medium may be included in or may be accessible to the speedometer correction device 114 of FIG. 1.

FIG. 3 shows another example flow diagram of the method 300 of correcting a vehicle speed configured to be displayed on a speedometer, arranged in accordance with at least some embodiments described herein. The method 300 may be performed in whole or in part by, e.g., the speedometer correction device 114 of FIG. 1. Although illustrated as discrete blocks, various blocks may be divided into additional blocks, combined into fewer blocks, or eliminated, depending on the desired implementation.

The method 300 may begin at block 302 in which a type of a vehicle and/or a type of a control module in the vehicle may be identified.

At block 304, a first speed-related parameter and one or more second speed-related parameters to be revised may be determined based on the type of the vehicle and/or the type of the control module. The first speed-related parameter may include a tire dimension parameter and the one or more second speed-related parameters may include a gear ratio parameter. Alternatively, the first speed-related parameter may include a gear ratio parameter and the one or more second speed-related parameters may include a tire dimension parameter.

At block 306, a user may be requested to update the one or more second speed-related parameters.

At block 308, one or more corrected values for the one or more second speed-related parameters may be received. For example, the method 300 may receive the one or more corrected values from the user.

At block 310, the one or more second speed-related parameters stored in the control module may be updated with the one or more corrected values. Alternatively, at block 310, the one or more corrected values for the one or more second speed-related parameters may be stored locally, e.g., in the speedometer correction device 114, to be transferred together with a corrected value of the first speed-related parameter to the control module at a later time.

The user may operate the vehicle to perform a drive cycle. At block 312, a reported vehicle speed and an actual vehicle speed may be received.

At block 314 a proportion between the reported and actual vehicle speeds may be determined.

At block 316, a corrected value for the first speed-related parameter may be determined based on the proportion between the reported and actual vehicle speed. The corrected value of the first speed-related parameter may account for a correction related to an actual change to a first speed-related attribute corresponding to the first speed-related parameter.

At block 318, an end of the drive cycle may be detected.

At block 320, the corrected value of the first speed-related parameter may be transferred to the control module to update the first speed-related parameter stored in the control module. Alternately or additionally, the one or more corrected values for the one or more second speed-related parameters may be transferred to the control module, together with the first speed-related parameter, to update the one or more second speed-related parameters.

Some embodiments disclosed herein include an article of manufacture such as a non-transitory computer storage medium having instructions stored thereon that are executable by a computing device to perform operations included in the method 300 of FIG. 3, such as the operations illustrated by blocks 302, 304, 306, 308, 310, 312, 314, 316, 318, and/or 320 in FIG. 3, and/or variations thereof. The non-transitory computer storage medium may be included in or may be accessible to the speedometer correction device 114 of FIG. 1.

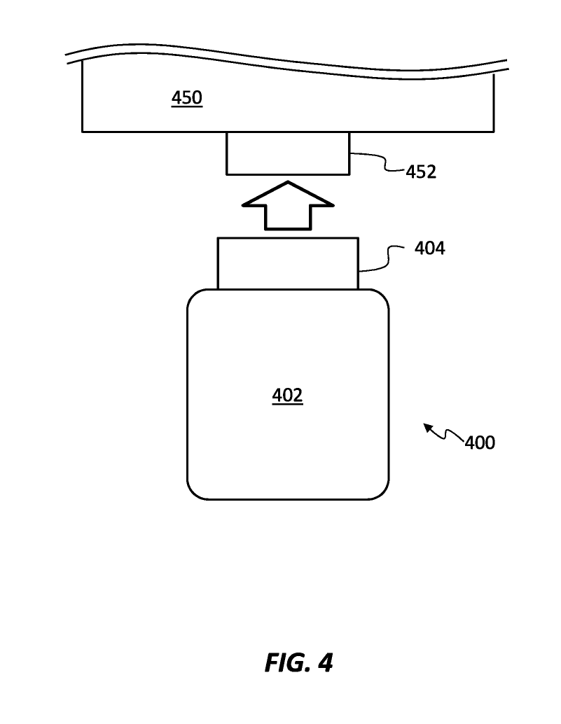

FIG. 4 is a representation 400 that illustrates an example speedometer correction device 402 and a portion of an example vehicle 450, arranged in accordance with at least some embodiments described herein. The speedometer correction device 402 may be connected to an OBD port 452 of the vehicle 450 using an OBD connector 404 included as part of the speedometer correction device 402. The speedometer correction device 402 and the OBD connector 404 are examples of, respectively, the speedometer correction device 114 and a particular configuration of the communication interface 115 of FIG. 1.

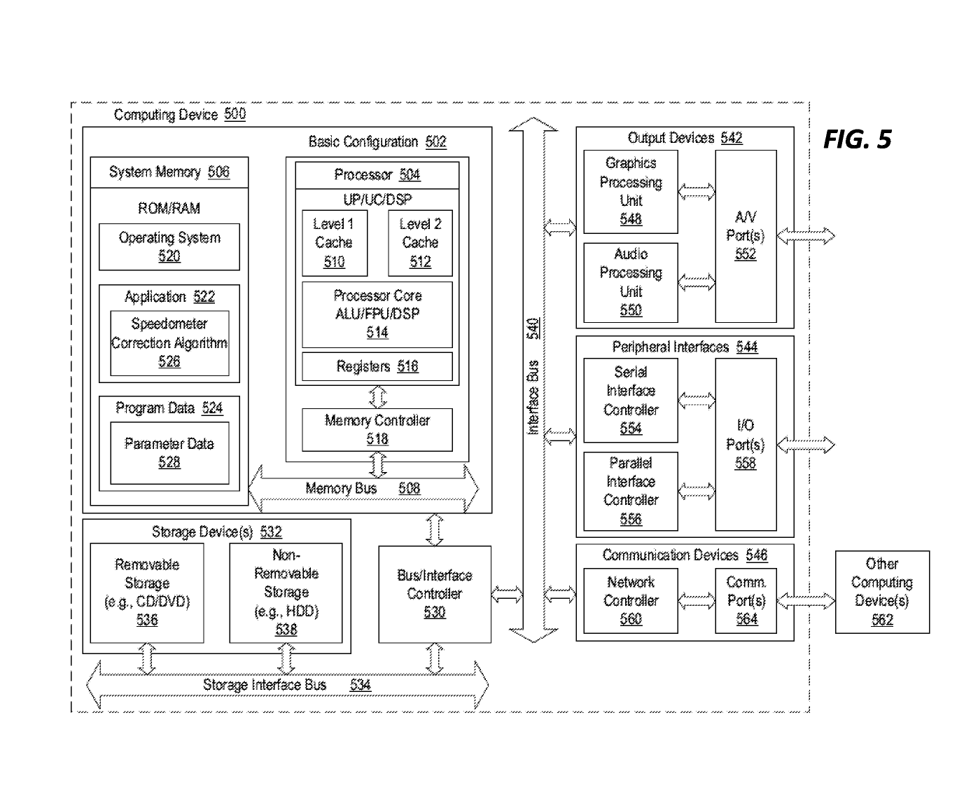

FIG. 5 is a block diagram that illustrates an example computing device 500 that is arranged for correcting a vehicle speed configured to be displayed on a speedometer, in accordance with at least some embodiments described herein. The example computing device 500 is shown for illustration purpose only. The example computing device 500 may be modified to implement various functionalities described herein. For example, one or more interfaces, buses, and/or other components may be removed from the computing device 500 and/or new components may be added to the computing device 500. Other variations to the computing device 500 are possible.

The computing device 500 may be included in or correspond to the speedometer correction device 114 of FIG. 1 or the speedometer correction device 402 of FIG. 4, for example. In a very basic configuration 502, the computing device 500 may typically include one or more processors 504 and a system memory 506. The processor 504 is an example of the processor 116 of FIG. 1. A memory bus 508 may be used for communicating between the processor 504 and the system memory 506.

Depending on the desired configuration, the processor 504 may be of any type including, but not limited to, a CPU, a μP, a μC, a DSP, or any combination thereof. The processor 504 may include one or more levels of caching, such as a level one cache 510 and a level two cache 512, a processor core 514, and registers 516. The example processor core 514 may include an arithmetic logic unit (ALU), a floating point unit (FPU), a digital signal processing core (DSP core), or any combination thereof. An example memory controller 518 may also be used with the processor 504, or in some implementations the memory controller 518 may be an internal part of the processor 504.

Depending on the desired configuration, the system memory 506 may be of any type including, but not limited to, volatile memory (such as RAM), non-volatile memory (such as ROM, flash memory), or any combination thereof. The system memory 506 may include an operating system (OS) 520, one or more applications 522, and program data 524. The application 522 may include a speedometer correction algorithm 526 that may be arranged to perform one or more of the functions as described herein including those described with respect to the methods 200 and/or 300 of FIGS. 2 and 3. The program data 524 may include parameter data 528 that may be pulled into the application 522 for analysis on the speedometer correction device 114 of FIG. 1, for example. In some embodiments, the application 522 may be arranged to operate with the program data 524 on the OS 520 such that implementations of methods for correcting a vehicle speed configured to be displayed on a speedometer, such as the methods 200 and 300 of FIGS. 2 and 3, may be provided as described herein.

The computing device 500 may have additional features or functionality, and additional interfaces to facilitate communications between the basic configuration 502 and any required devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer-readable instructions, data structures, program modules, or other data.

The system memory 506, removable storage devices 536, and non-removable storage devices 538 are examples of computer storage media in general and of the storage medium 118 of FIG. 1 in particular. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., output devices 542, peripheral interfaces 544, and communication devices 546) to the basic configuration 502 via the bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device) or other peripheral devices (e.g., printer, scanner) via one or more I/O ports 558. The example communication device 546 may include a network controller 560, which may be arranged to facilitate communications with one or more other computing devices 562 over a network communication link via one or more communication ports 564.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application-specific device, the speedometer correction device 114 or 402 of FIG. 1 or 4, or a hybrid device that includes any of the above functions. The computing device 500 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of correcting a vehicle speed configured to be displayed on a speedometer, the method comprising:
identifying a type of a control module in a vehicle;
determining a speed-related parameter to be revised based on the type of the control module;
receiving a reported vehicle speed and an actual vehicle speed;
determining a proportion between the reported vehicle speed and the actual vehicle speed;
determining a corrected value for the speed-related parameter based on the proportion between the reported vehicle speed and the actual vehicle speed;
detecting an end of a drive cycle; and
transferring the corrected value of the speed-related parameter to update the control module after detecting the end of the drive cycle.

2. The method of claim 1, wherein the corrected value of the speed-related parameter accounts for corrections related to an actual change to a speed-related attribute that corresponds to the speed-related parameter and one or more actual changes to one or more other speed-related attributes that correspond to one or more other speed-related parameters.

3. The method of claim 2, wherein the speed-related parameter includes a tire dimension parameter of the vehicle and the one or more other speed-related parameters include a gear ratio parameter of the vehicle.

4. The method of claim 2, wherein the speed-related parameter includes a gear ratio parameter of the vehicle and the one or more other speed-related parameters include a tire dimension parameter of the vehicle.

5. The method of claim 1, wherein the speed-related parameter includes a tire dimension parameter of the vehicle and the corrected value includes a product of an existing value of the tire dimension parameter and the proportion between the reported vehicle speed and the actual vehicle speed.

6. The method of claim 1, wherein detecting the end of the drive cycle comprises detecting occurrence of one or more actions that signal the end of the drive cycle.

7. A method of correcting a vehicle speed configured to be displayed on a speedometer, the method comprising:
identifying a type of a control module in a vehicle;
determining a first speed-related parameter and one or more second speed-related parameters to be revised based on the type of the control module;
receiving one or more corrected values for the one or more second speed-related parameters;
updating the one or more second speed-related parameters stored in the control module with the one or more corrected values;
receiving a reported vehicle speed and an actual vehicle speed;
determining a proportion between the reported vehicle speed and the actual vehicle speed;
determining a corrected value for the first speed-related parameter based on the proportion between the reported vehicle speed and the actual vehicle speed;
detecting an end of a drive cycle; and
transferring the corrected value of the first speed-related parameter to update the control module.

8. The method of claim 7, wherein the corrected value of the first speed-related parameter accounts for a correction related to an actual change to a first speed-related attribute that corresponds to the first speed-related parameter.

9. The method of claim 7, wherein the first speed-related parameter includes a tire dimension parameter of the vehicle and the one or more second speed-related parameters include a gear ratio parameter of the vehicle.

10. The method of claim 7, wherein the first speed-related parameter includes a gear ratio parameter of the vehicle and the one or more second speed-related parameters include a tire dimension parameter of the vehicle.

11. The method of claim 7, wherein the speed-related parameter includes a tire dimension parameter of the vehicle and the corrected value includes a product of an existing value of the tire dimension parameter and the proportion between the reported vehicle speed and the actual vehicle speed.

12. The method of claim 7, wherein detecting the end of the drive cycle comprises detecting one or more actions that signal the end of the drive cycle.

13. The method of claim 12, wherein detecting occurrence of the one or more actions comprises:
detecting a stop of the vehicle; and
detecting that an ignition of the vehicle is turned off for at least a period of time.

14. A speedometer correction device comprising:
a communication interface for communicatively coupling to a control module of a vehicle;
a processor; and
a non-transitory computer storage medium having computer instructions stored thereon that are executable by the processor to perform operations comprising:
identifying a type of the control module of the vehicle;
determining a speed-related parameter to be revised based on the type of the control module;
receiving a reported vehicle speed and an actual vehicle speed;
determine a proportion between the reported vehicle speed and the actual vehicle speed;
determining a corrected value for the speed-related parameter based on the proportion between the reported vehicle speed and the actual vehicle speed;
detecting an end of a drive cycle; and
transferring the corrected value of the speed-related parameter to update the control module.

15. The speedometer correction device of claim 14, wherein the control module is identified based at least in part on information received via the communication interface.

16. The speedometer correction device of claim 14, further comprising a global positioning service (GPS) sensor for determining the actual vehicle speed.

17. The speedometer correction device of claim 14, wherein the communication interface is further communicatively coupled to a global positioning service (GPS) sensor of the vehicle.

18. The speedometer correction device of claim 14, wherein the speed-related parameter includes a tire dimension parameter of the vehicle.

19. The speedometer correction device of claim 14, wherein the speed-related parameter includes a gear ratio parameter of the vehicle.

20. The speedometer correction device of claim 14, wherein detecting the end of the drive cycle comprises detecting one or more actions that signal the end of the drive cycle, the one or more actions including at least one of:
detecting a stop of the vehicle;
detecting an input from a user;
detecting that the vehicle speed has achieved a threshold value;
detecting that the vehicle is located at a geographic location; and
detecting that an ignition of the vehicle is turned off for at least a period of time.
